(19) United States
(12) Patent Application Publication
(10) Pub. No.: US 2024/0407972 A1
(43) Pub. Date: Dec. 12, 2024

(54) SENSOR UNIT FOR ATTACHMENT TO A LIQUID DISPENSER, AND LIQUID DISPENSER COMPRISING SUCH A SENSOR UNIT

(71) Applicant: Aptar Radolfzell GmbH, Radolfzell (DE)

(72) Inventors: Jörg KOHNLE, Villingen-Schwenningen (DE); Joachim KÖRNER, Uhldingen-Mühlhofen (DE)

(21) Appl. No.: 18/701,389

(22) PCT Filed: Oct. 5, 2022
(86) PCT No.: PCT/EP2022/077729

§ 371 Date: Apr. 15, 2024

(30) Foreign Application Priority Data
Oct. 21, 2021 (EP) 21203894.7

(51) Int. Cl. A61J 1/16; A61J 1/06

(52) U.S. Cl. CPC A61J 1/16; A61J 1/067; A61J 2200/30

(57) ABSTRACT

A sensor unit for exchangeable attachment to the bottom portion of a liquid store of a liquid dispenser. The sensor unit has an annular wall structure which surrounds a receiving space, closed on the bottom side by a receiving space base, for receiving the bottom portion of the liquid store. The sensor unit has at least one sensor for detecting the handling of the liquid dispenser. To fasten the liquid store in the sensor unit, at least one inwardly pointing and radially movable clamping face for bearing in a securing manner against an outer surface of the liquid store is provided on the inner side of the annular wall structure.

### AREA OF APPLICATION AND PRIOR ART

The invention concerns a sensor unit for attachment to a liquid dispenser, and a liquid dispenser comprising such a sensor unit.

A sensor unit in the sense of the invention is a unit which can be handled separately, is designed for coupling to a liquid dispenser and has at least one sensor which is suitable for detecting the handling of the liquid dispenser. Such a sensor may for example be configured as a movement sensor which detects the movement of the liquid dispenser, or as a force or pressure sensor which detects the actuation of the dispenser for the purpose of liquid delivery.

The generic sensor unit is provided for releasable attachment to the bottom portion of a liquid store. It is thus possible to use the sensor unit successively or alternately on different liquid stores of different liquid dispensers. When a liquid store is empty, the sensor unit can be detached therefrom, the liquid store or the liquid dispenser complete with liquid store replaced, and the sensor unit attached to a new liquid store.

### OBJECT AND SOLUTION

The object of the invention is to provide a sensor unit which allows reliable exchange of the liquid store. The object of the invention is furthermore to provide a liquid dispenser comprising such a sensor unit.

According to the invention, a sensor unit of the generic type is provided for exchangeable attachment to the bottom portion of a liquid store. This sensor unit has at least one sensor which is suitable for detecting the handling of the liquid dispenser, in particular its movement and/or actuation.

A sensor unit according to the invention has an annular wall structure which surrounds a receiving space, closed on the bottom side by a receiving space floor, for receiving the bottom portion of the liquid store. The receiving space is preferably substantially rotationally symmetrical, and further preferably is formed to receive liquid stores with circular cylindrical casing surface. The wall structure may be circumferentially closed. It may however also have interruptions or be formed from a plurality of wall segments.

The receiving space is open at the top and serves for insertion of the bottom portion of the liquid store from this open end. The liquid store is releasably coupled to the sensor unit in the region of the receiving space.

For this, according to the invention, four variants are proposed, which may also be used in combination, to guarantee that the sensor unit is held on the liquid store as securely as possible. The common feature of the variants is that they allow reuse of the sensor unit with repeatedly changed liquid stores.

According to the first variant, an adhesive element is provided which is arranged between the receiving space floor and the bottom portion of the liquid store, and thus secures the liquid store in the receiving space.

According to the second variant, on the inside of the annular wall structure, at least one inwardly pointing and radially movable clamping face is provided for bearing in securing fashion against a casing surface of the liquid store.

According to the third variant, on the inside of the annular wall structure, a circumferential seal is provided for bearing against a casing surface of the liquid store and, together with the casing surface and the bottom portion of the liquid store, delimits an isolated pressure chamber.

According to the fourth variant, on the inside of the annular wall structure, a thread structure is provided for bearing in securing fashion against a casing surface of the liquid store, wherein the thread structure has an inner diameter which is smaller than an outer diameter of the casing surface.

Features and details of the four variants are described below.

In the first variant, an adhesive element is provided which is adhesively attached to at least one contact face. This at least one contact face may be provided on the bottom portion of the liquid store or on the receiving space floor of the receiving space. The inward-facing side of the wall structure preferably has no adherable surfaces, so that an adhesive connection is created only on the bottom portion. This facilitates handling and allows use of the sensor unit with liquid stores of different diameter.

Although designs are possible in which the adhesive element is applied to the respective other contact face without adhesive connection, it is preferred if the adhesive element is formed as an adhesive element with adhesive surfaces on both sides, so that it is adhesively attached both to the contact face of the bottom portion and also to that of the receiving space floor.

The adhesive element is preferably adhesively attached on one side directly to a body integrally forming the liquid store and in contact with the liquid, in particular to the direct outside of a glass or plastic bottle. On the other side it is adhesively attached to the receiving space floor.

If an adhesive element with adhesive surfaces on both sides is used, it is preferred if the adhesive surface adhering to the receiving space floor has a greater separating force than the adhesive surface adhering to the bottom portion of the liquid dispenser. The adhesive element therefore continues to adhere to the sensor unit when the sensor unit is separated from the liquid store and correctly reused, if the remaining adhesive force allows. The greater separating force on the bottom portion side may be achieved inter alia by the design of the respective surfaces and/or by contact areas of different size.

In particular, the adhesive element may be formed from a polymer gel with adhesive properties. Such adhesive elements retain their adhesive force for a long time and are therefore particularly suitable for reusability.

The adhesive element is preferably arranged such that it bears against the receiving space floor. It may cover this over a large area. However, an annular structure with central cutout is preferred. This facilitates mounting. Also, in the case of conventional bottom portions of liquid stores which have a central depression, no adhesion is possible in the middle so the annular structure does not reduce the retention force.

In the case of the second variant, at least one radially displaceable clamping face is provided in the region of the wall structure of the sensor unit which bears against the casing surface of the liquid store under radial displacement, and clamps this such that separation of the liquid store from the sensor unit becomes sufficiently more difficult, so as to remain secured thereto under normal loading in everyday use.

To achieve the desired clamping effect, at least two clamping faces must be provided, of which however only one need be radially movable. It is advantageous if more than two clamping faces are provided so that the liquid store is held more securely thereby. The at least two clamping faces, in clamping state, press from the outside onto the casing surface of the liquid store so that the liquid store is held by friction fit between the clamping faces. In addition, the clamping faces may also achieve a form fit if the bottom portion of the liquid store has a larger cross-section, above which the clamping faces bear on the casing surface.

The second variant comprises both embodiments in which the clamping face or clamping faces can be deflected by switch means so that the liquid store can then be inserted in the receiving space, and also embodiments in which the clamping faces are deflected by the insertion of the liquid store.

Preferably, the clamping faces are displaceable relative to one another such that liquid containers with different diameters can be securely held. In particular, it is preferably provided that at least liquid stores with diameters deviating by 5% can be securely held.

In a possible form of the second variant of the invention, multiple discrete clamping faces are distributed around the circumference, in particular at least two, four, six or eight clamping faces. Discrete clamping faces mean that between these clamping faces, regions are provided in which the sensor unit does not bear against the casing surface. The discrete clamping faces are however preferably, at least partly, portions of an integral component. As explained above, not all clamping faces need be radially displaceable. It is however preferred that all clamping faces are radially displaceable, e.g. by means of a common tensioning member as will be explained below.

In an alternative embodiment, the at least one clamping face is formed by a single clamping face spanning the casing surface over more than 180° or a helical clamping face. Such a clamping face may, because of elastic deformation, deploy the clamping effect by exerting a radial force on the liquid store circumferentially or over a large angular region. A clamping face spanning the casing surface over more than 180° can alone deploy the desired clamping effect. A helical clamping face with at least one turn may bear circumferentially against the casing surface of the liquid store.

Preferably, the at least one clamping face is provided on an at least partially radially elastically deflectable clamping element. This allows the liquid store to be inserted in the receiving space against the return force of the clamping element without additional switching means. If a switching means is provided, designs are also possible in which an elasticity of the components of the clamping mechanism is not required.

In a structurally comparatively simple variant, it is provided that at least one clamping element is configured as a clamping element formed integrally with the annular wall structure. In particular, several or all clamping elements may be formed integrally with the wall structure. Such an integral design is advantageous for achieving a low production cost. The clamping elements formed integrally with the wall structure are preferably provided with a radially compressible deformation region. This deformation region is here in particular preferably formed by integral part portions of the wall structure.

As an alternative to such a one-piece design, also at least one clamping element may be provided which is separate from the annular wall structure and can be deflected or widened relative to the annular wall structure, in order to allow insertion of the liquid store. In particular, it may be provided here that the clamping element is manually deflected or widened by a switching means before the liquid store is inserted in the receiving space.

In a possible variant thereof, said clamping element is formed by a widenable ring which at least largely surrounds the liquid store, or a widenable leg spring which surrounds the liquid store at least once. In particular, it may be provided that one end of the ring or leg spring is stationarily attached to the annular wall structure or directly attached to said wall structure, and the other end of the ring or leg spring is movable for widening the ring or leg spring, wherein this other end is preferably connected to a handle so as to move the end easily in the circumferential direction and thereby elastically widen the inner diameter of the ring or leg spring.

In another preferred design, at least two clamping faces are provided which are arranged opposite one another on the inside of a circumferential clamping ring. In the fully elastically relaxed state, the clamping ring has an oval form which is deformable elastically in the direction of a circular form under direct or indirect radial force loading. The oval form has a small half axis which is smaller than the diameter of the liquid store. Because of this design, the clamping ring is deformable under external force loading such that the liquid container can be inserted without force. When the external force loading is removed, it bears against the liquid container and thereby clamps the latter.

Although a single such clamping ring can already deploy a sufficient force for clamping the liquid store, it is advantageous if at least two and in particular precisely two such clamping rings are provided.

These clamping rings are preferably rotationally offset to one another or can be twisted into a rotationally offset arrangement so that in clamped state, the liquid store is clamped by at least four circumferentially distributed clamping faces. In a design in which the clamping rings are rotatable, it may be provided that the clamping rings at corresponding angular positions are deformed for insertion of the liquid store, and after clamping of the liquid store, one of the clamping rings is twisted e.g. through 90°.

Preferably however, the clamping rings may be arranged such that the larger half axes of the fully relaxed oval forms are set at a fixed angle to one another, preferably 90°. In the case of such an arrangement, the force for widening in the direction of the round form is applied offset by this angle.

For force loading of the at least one clamping ring, switch elements may be provided for manual force loading, wherein these switch elements preferably protrude through the annular wall structure and/or wherein these switch elements may preferably be arranged integrally on the respective clamping rings.

These switch elements for deforming the ring elements are preferably radial push-in switch elements. The switch elements may in particular be provided at mutually opposite ends of the oval ring form, aligning with the large half axis of the oval form.

In particular in a design with two offset clamping rings, but also in a design with only one clamping ring, it may be advantageous if, for force loading of the at least one clamping ring, at least one switch element is provided which is movable relative to the wall structure and formed as a component separate from the clamping ring. In a preferred design, on an inside of the switch element separate from the clamping ring, a force-loading face may be provided for force loading of at least one clamping ring.

In such a design, a separate component is thus provided which is manually directly force-loaded by the user and indirectly force-loaded by the clamping ring or rings. In particular, it may preferably be provided that said switch element is formed as a rotatable and preferably circumferential switch ring. This switch ring is suitably twisted for widening the at least one clamping ring. The force-loading face provided on the switch element is preferably a slide face oblique to the rotational direction, so that indirectly a radial displacement of the clamping rings and by association a deformation occurs. In the case of two offset clamping rings, as a common switch element, a switch element may simultaneously deform both clamping rings with corresponding slide faces, and thus particularly easily create a non-clamping state suitable for insertion of the liquid store.

Another embodiment of the second variant of the invention provides that the clamping face is formed by an inside face of the clamping element which consists of an elastically compressible material and preferably has a circumferential sleeve structure. In particular, a foamed material or similar material may be used. The compression hardness of the material is preferably maximum 6 kilopascal. The thickness of the material in uncompressed state is preferably at least 0.5 mm, in particular preferably at least 1 mm. Greater thicknesses may also be suitable, in particular to improve the usability of the sensor unit for liquid stores with different diameters.

The material of the clamping element is compressed when the bottle body is inserted, so that a clamping force is exerted on the bottle body. The in particular sleeve-like clamping element or multiple clamping elements are provided on the inside of the wall structure.

A combination with the above-mentioned adhesive elements may be advantageous, so that the liquid store is held firstly by the adhesive element by the adhesive effect, and secondly laterally supported by the compressible clamping element and held by friction fit.

In a further design of the second variant of the invention, at least one axially movable clamping sleeve is provided, wherein the clamping sleeve may in particular be a threaded sleeve which can be displaced in a superposed rotational and axial movement. The threaded sleeve preferably has a grip face on the outside for turning by hand, so that the axial displacement takes place indirectly.

Furthermore, in this embodiment, a plurality of clamping faces is provided which are radially displaced by the axial displacement of the clamping sleeve in order to bear from the outside against the casing surface of the liquid store and clamp this. These clamping elements may be provided as components separate from the clamping sleeve. Particularly preferably however, they are provided on the clamping sleeve itself.

The radial displacement of the clamping faces takes place in particular via a wedge drive which transfers the axial movement of the clamping sleeve into the radial movement of the clamping faces.

According to the third variant, the sensor unit is configured such that together with the liquid store, it forms an at least temporarily isolated pressure chamber. This pressure chamber holds the liquid store because, when the liquid store is extracted, a vacuum is formed or amplified in the pressure chamber which hinders extraction. In the simplest case, the sensor unit is provided with a sealing lip which isolates the pressure chamber on insertion of the liquid store, but at least partly dissipates the occurring positive pressure by brief separation of the sealing lip from the casing surface. This ensures that the described vacuum can be created on subsequent extraction.

A possible additional measure provides that the pressure chamber has a part chamber with variable volume, the volume of which is manually changeable by means of a switch element. This allows insertion of the liquid store with minimal volume of the part chamber, and enlargement of the part chamber after insertion so that the vacuum is thereby increased.

Another possibility for refinement of the third variant of a sensor unit according to the invention is to provide a pressure-balancing channel which connects the pressure chamber to an environment, wherein furthermore a manually switchable valve is provided, by means of which the pressure-balancing channel can be closed so that the pressure chamber is thereby isolated.

This allows the pressure chamber delimited by the sensor unit and the outside of the liquid store to be connected to the environment during insertion of the liquid store, so that no or only a slight positive pressure is created. As soon as the liquid store is inserted, the valve is closed so that the pressure chamber is isolated and a vacuum counters a traction force on the liquid store. If the liquid store is to be changed, the valve is opened and the liquid store can easily be withdrawn with simultaneous pressure balancing. The valve is preferably pushed into the closed position by spring force and opened by manual force application.

According to the fourth variant, the sensor unit is formed with a thread structure in the form of an internal thread. The thread structure may be formed from individual helical portions or from one or more continuous thread turns. The liquid store may provide corresponding depressions in the region of the casing surface, in the manner of an external thread, which are introduced during production. It is however advantageous if the liquid store has a circular cylindrical casing surface, since this is usually the case with liquid stores not specifically adapted to sensor units. The casing surface is then compressed only slightly in the region of the thread structure of the sensor unit when the sensor unit is screwed on. It is also possible to design the thread structure on the sensor unit with sharp edges such that it cuts a thread when screwed onto the liquid store.

As well as the sensor unit, the invention also comprises a liquid dispenser with a sensor unit of the type described. The liquid dispenser has a closed liquid store on which, on the side facing away from a delivery head, a closed bottom portion is provided. The sensor unit of said type is attached thereto.

The liquid store is preferably configured as a manually deformable squeeze bottle.

The dispenser itself is preferably a drop dispenser. Particularly preferably, it has a drop formation geometry adjoining the delivery opening, at which liquid is deposited until it detaches under force of gravity. The drop formation geometry may be flared. Also, a substantially flat drop formation geometry is possible, in particular with external breakaway edge.

In particular, the dispenser may be filled with pharmaceutical liquid, for example with liquid for ophthalmic application.

The sensor unit according to the invention is provided for removable attachment to the bottom portion of the liquid store. The sensor unit may be used successively or in some cases alternately on different liquid stores of different liquid dispensers. When a liquid store is empty, the sensor unit can be detached, the liquid dispenser or liquid dispenser complete with liquid store replaced, and the sensor unit attached to a new liquid store.

### BRIEF DESCRIPTION OF THE DRAWINGS

Further advantages and aspects of the invention arise from the claims and the following description of preferred exemplary embodiments of the invention, which are explained below with reference to the figures.

FIGS. 1A and 1B show the basic structure of a sensor unit according to the invention.

FIGS. 2A to 2D show the proper use of the sensor unit is part of a liquid dispenser with sensor unit.

FIGS. 3A to 3C show a sensor unit according to the first variant of the invention.

FIGS. 4A to 4C show a sensor unit according to the second variant of the invention in which elastically deflectable clamping faces are distributed around the circumference.

FIGS. 5A to 5C show a sensor unit according to the second variant of the invention in which a clamping face is formed by the inside of the leg spring.

FIGS. 6A to 6C show a sensor unit according to the second variant of the invention in which an elastically compressible sleeve is provided, the inside of which forms a clamping face.

FIGS. 7A to 7D show a sensor unit according to the second variant of the invention in which a deformable oval ring has clamping faces.

FIGS. 8A to 8D show a sensor unit according to the second variant of the invention in which two deformable oval rings have clamping faces.

FIGS. 9A to 9D show a sensor unit according to the second variant of the invention in which two deformable oval rings have clamping faces and also a switch element is provided for common handling of the oval rings.

FIGS. 10A to 10C show a sensor unit according to the second variant of the invention in which an axially displaceable clamping sleeve has clamping faces.

FIGS. 11A to 11C show a sensor unit according to the third variant of the invention in which a pressure chamber of the sensor unit can be connected to the environment via a pressure-balancing channel.

FIGS. 12A to 12C show a sensor unit according to the third variant of the invention in which the pressure chamber has a part chamber with changeable volume.

FIGS. 13A and 13B show a sensor unit according to the fourth variant of the invention in which the sensor unit has an internal thread.

### DETAILED DESCRIPTION OF EXEMPLARY EMBODIMENTS

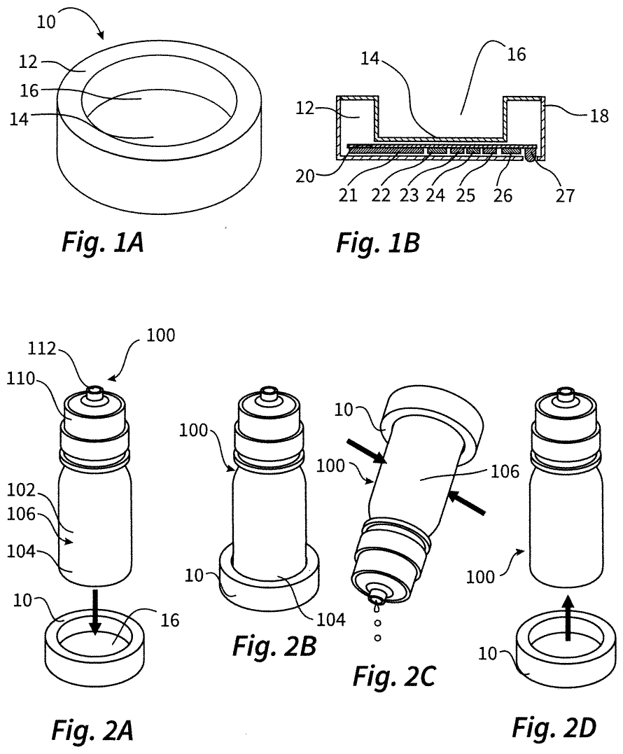

FIGS. 1A and 1B show a sensor unit 10 according to the invention which is properly attached to the bottom portion 104 of the liquid store 102 of a liquid dispenser 100. FIGS. 1A and 1B and the following FIGS. 2A to 2D serve initially to illustrate the basic function. The respective fixing means for fastening the bottom portion 104 of the liquid store 102 are shown in the further figures.

The basic design of the sensor unit 10 according to the invention as shown in FIG. 1A provides that the sensor unit 10 has a cup-like structure with a receiving space floor 14 and a surrounding wall structure 12. Although in the exemplary embodiments shown, the wall structure 12 is a circumferential wall structure, designs are possible in which the wall structure has interruptions. Thus for example three elements, each extending over 90° and circumferentially spaced from one another, may also form a wall structure in the sense of the invention.

As illustrated by the schematic sectional drawing in FIG. 1B, a sensor unit 10 according to the invention has electronic components which serve for detecting the handling of the liquid dispenser 100. As an example, FIG. 1B shows a circuit board 20 with a battery 21, a microprocessor 22, sensors 23 to 25, a radio communication module 26 and a status LED 27. These electronic components are arranged in a bottom region of the sensor unit 10 externally delimited by a housing 18.

The electronic components allow the detection of sensor data so as to establish sensor data and data sequences characteristic of the handling and/or operation of the liquid dispenser. In the present case, the sensors are for example a movement sensor 23 which can detect the position and acceleration of the sensor unit 10, an acoustic sensor 24 which can detect noise connected with the operation or handling, and a temperature sensor 25 which may for example be used to detect a temperature rise in connection with gripping of the dispenser. The microprocessor 22 processes the sensor data, wherein in the simplest case processing may be restricted to wireless transmission via the communication device 26, for example transmission to a smartphone of the user or an analysis server. In other embodiments, it is also conceivable that the microprocessor 22 itself analyses the data without requiring communication with an external system.

Detection of the handling data may serve various purposes. In particular, detection may serve to identify usage processes and check the correct handling by the user.

Thus for example it is possible to monitor whether a patient is receiving medicaments according to a medication plan. This may be useful in particular for achieving a high data quality in clinical studies. It is also possible to use a sensor unit 10 of the described type for implementing a counter, by means of which the user can estimate how many applications are still possible with the liquid remaining in the liquid store 102. When designed as a counter, it is advantageous if a display device is provided in addition to the described electronic components.

FIGS. 2A to 2D illustrate the correct use of a sensor unit 10. During this use, as shown in FIG. 2A, the bottom portion 104 of a liquid store 102 of a liquid dispenser 100 is inserted in the receiving space 16 of the sensor unit 10, where a firm hold is guaranteed using the means to be described below. In many designs described below, it is provided that the sensor unit can be switched manually between a clamping and a non-clamping state. In such cases, the liquid store 102 is inserted after switching to the non-clamping state. The sensor unit 10 is then transferred to the clamping state. In other designs, insertion takes place without prior preparation of the sensor unit 10, e.g. in that elastically deflectable elements are deflected on insertion and then exert a clamping force on the inserted liquid store 102.

In the coupled state shown in FIG. 2B, the medicament dispenser may be used as intended, wherein because it is attached to the liquid store, the sensor unit is always moved therewith. A use of the liquid dispenser 100 is illustrated in FIG. 2C using the example of a drop dispenser. In the case of this exemplary embodiment, the liquid store 102 takes the form of a squeeze bottle. In the illustrated upside-down position of the liquid dispenser 100 with connected sensor unit 10, the casing surface 106 of the liquid store 102 is force-loaded on both sides so a drop can be delivered.

As soon as the liquid store 102 is empty, the liquid dispenser 100 may be separated as a whole from the sensor unit 10 as shown in FIG. 2D. Assuming sufficient force is applied, the liquid store 102 can easily be withdrawn from the sensor unit 10, where applicable—depending on design—after prior transfer of the sensor unit to the non-clamping state. In principle, the aim is for the traction force necessary to extract the liquid store 102 from the secured or clamped state in sensor units according to the invention to be no more than 5 Newtons, so that unintentional separation is not initially to be expected.

After removal of the empty liquid store, the sensor unit 10 may be attached to a new liquid dispenser 100.

The electronic components are in particular configured to detect the position change of the liquid dispenser 100 in connection with a delivery. It is clear from FIG. 2C that the dispenser assumes a characteristic position when used for delivery. This position, and where applicable movement sequences for reaching this position or after reaching this position, can be detected and analyzed as a sign of completed delivery. The sensor unit 10 may have sensors or be connected to additional sensors in order to detect the operation or delivery itself, e.g. using the described acoustic sensor 24 or a sensor module structurally separate from the sensor unit 10 for detecting drops in the region of the delivery opening 112. For many applications however, it is sufficient to analyze merely the movement sequence of the liquid dispenser 100 with coupled sensor unit 10 in order to detect a delivery process with sufficient certainty.

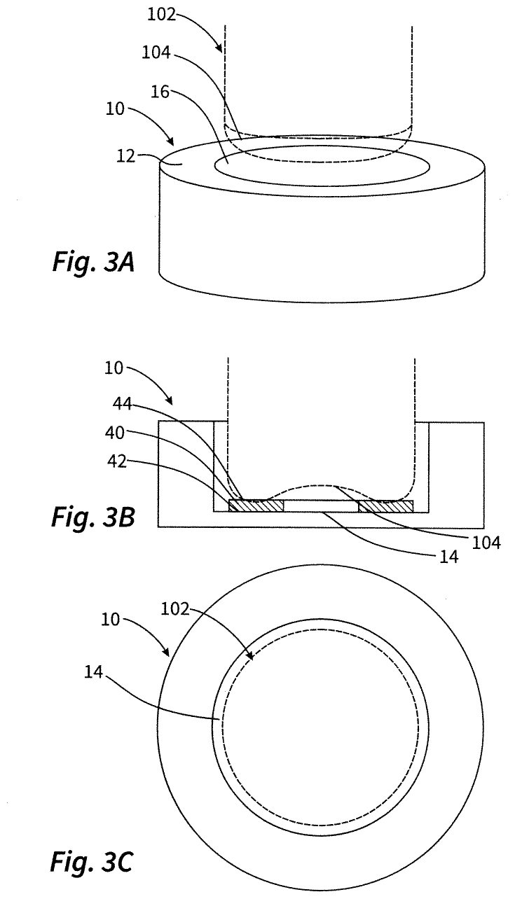

FIGS. 3A to 3C show a first embodiment of a sensor unit 10 and liquid store 102 coupled thereto for creating a permanent but releasable connection. As evident in particular from FIG. 3B, an annular adhesive element 40 is provided on the receiving space floor 14. This has adherable adhesive surfaces 42, 44 on its top and bottom. In particular, the adhesive element 40 may be an adhesive made of a polymer gel with adhesive properties. The lower adhesive surface 42 serves to attach the adhesive element 40 to the receiving space floor 14. The upper adhesive surface 44 fastens the adhesive element 40, in the state in FIG. 3B, to the bottom portion 104 of the liquid store 102. The annular form facilitates mounting and, in the case of recessed bottom portions 104 of conventional medicament bottles, does not lead to a significant reduction in contact area.

The adhesive element 40 is preferably attached more firmly to the receiving space floor 14 than to the liquid store 102 because of the larger adhesion surface or respective material properties. When the liquid store 102 is deliberately extracted from the sensor unit 10, the adhesive element therefore remains on the sensor unit 10. Then a new liquid dispenser 100 with liquid store 102 may be pressed against the adhesive surface 44 in order to achieve firm attachment again. The above-mentioned polymer gel with adhesive properties, with a suitable choice of the polymer gel, usually allows attachment of the same sensor unit 10 to new liquid stores 102 multiple times, in particular at least five to ten times, before the adhesive force no longer allows this. In this case, the user may use a new adhesive element 40.

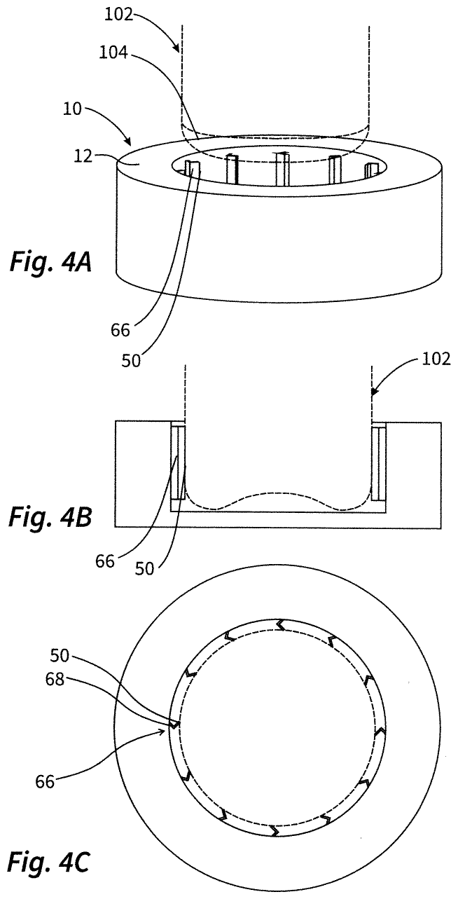

FIGS. 4A to 4C show a design of the sensor unit 10 in which a total of twelve clamping elements 66 are provided on the inside of the wall structure 12, each having a deformation region 68 with mutually angled surface elements and an inside clamping face 50. The clamping faces 50 are arranged circumferentially, wherein in the state of FIG. 4A they together define a diameter which is smaller than the diameter of the liquid store 102. When the liquid store 102 is pressed into the sensor unit 10 in the manner shown in FIG. 4B, the deformation regions 68 are deformed such that the clamping faces 50 are pressed radially outward. This elastic deformation of the deformation regions 68 causes the clamping elements 66 to each apply a clamping force on the casing surface 106 of the liquid store 102 so that this is adequately held.

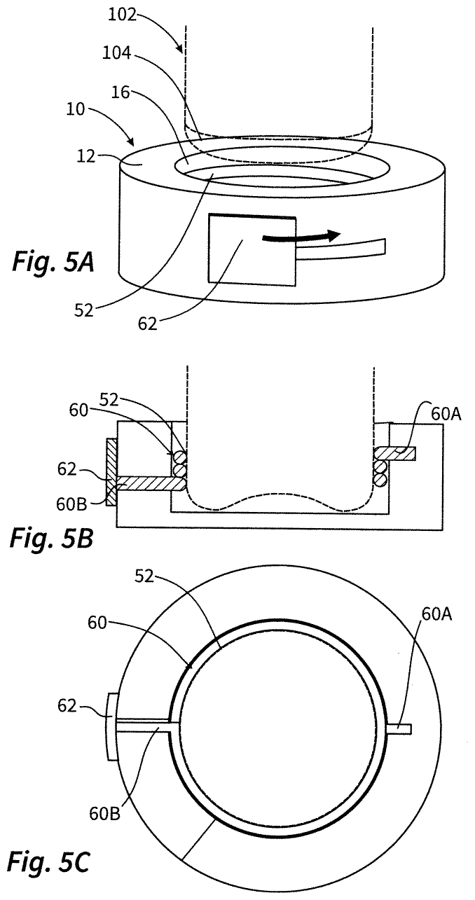

FIGS. 5A to 5C show a further design. It is evident in particular from FIG. 5B that the particular feature of this design of the sensor unit 10 is that a leg spring 60 is arranged in the edge region of the receiving space 16. A leg end 60A of this leg spring 60 is firmly attached to the wall structure 12 of the sensor unit 10. The other leg end 60B is attached to a handle 62 which is movable in the circumferential direction of the sensor unit 10.

By moving the handle 62 relative to the housing 18 of the sensor unit 10 according to the arrow in FIG. 5A, the leg spring 60 can be tensioned and hence the inner diameter of its windings enlarged. In this enlarged state, the liquid store 102 can then be inserted in the receiving space 16 without application of substantial force. If the force loading on the handle 62 is then removed, the inner diameter of the leg spring 60 is reduced again and the insides of the windings, which simultaneously form clamping faces 52, bear on the outside circumferentially against the casing surface 106 of the liquid store 102. This creates a great holding force which prevents separation of the liquid store 102 from the sensor unit 10 until the handle 62 is moved again so as to widen the leg spring 60 again, so that the liquid store 102 can be removed and replaced with a new one.

Although the leg spring 60 shown is illustrated with 2.5 turns, a lower number of turns may also be provided. If only 1.5 turns are provided, the inner diameter can be increased by around 4% merely by displacing the leg end 60B through just 20° by means of the handle 62.

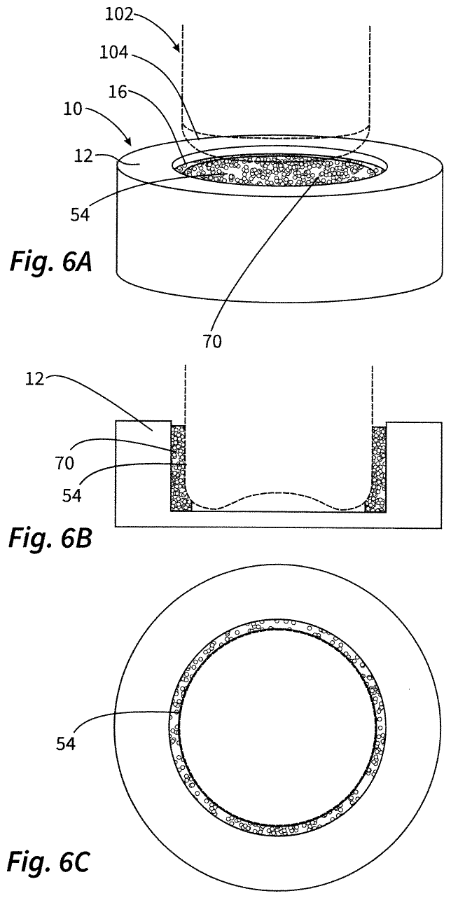

FIGS. 6A to 6C show a design in which a foamed material ring 70 is inserted as a clamping element on the inside of the wall structure 12. The inside of this foamed material ring 70 forms a clamping face 54. When the liquid store 102 is pressed into the receiving space 16, the foamed material ring 70 is radially compressed as shown in FIG. 6B, to achieve the necessary holding force. If sufficient force is applied, the liquid store 102 can however be removed from the sensor unit 10 and the clamping element 70 therein for exchange. The clamping element 70 may be fixed to the wall structure 12, in a manner not illustrated, by mechanical means or by an adhesive. Alternatively, the foamed material ring 70 may have a degree of oversize on the outside in order to remain securely in the receiving space 16 without additional fixing means. This has the advantage that the foamed material ring 70 can be exchanged if required.

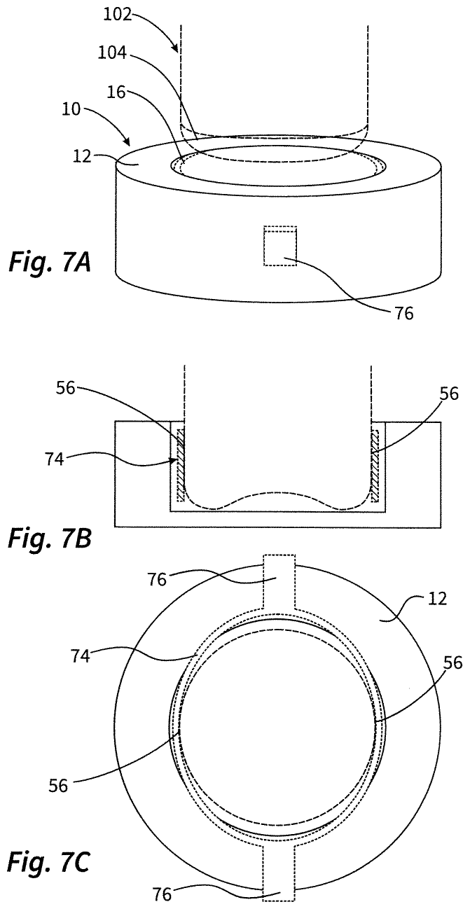

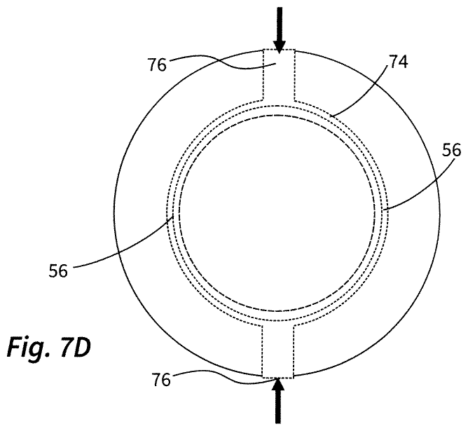

In the design in FIGS. 7A to 7D, it is provided that a clamping element is provided in the receiving space 16 in the form of a clamping ring 74 which is approximately oval in the relaxed state. Switch elements 76 are provided at two opposite ends of this clamping ring 74, which extend through openings in the wall structure 12 (not shown in detail) and can thereby be force-loaded from the outside. As FIG. 7D illustrates, a force loading in the region of the switch elements 76 towards one another leads to a deformation of the clamping ring 74 in the direction of a more circular form. In this non-clamping state in FIG. 7D, the liquid store 102 can be inserted in the receiving space 16. When the force loading is removed from the switch elements 76, the clamping ring 74 returns elastically to its starting position as far as the inserted liquid store 102 allows. The inside of the clamping ring 74 forms two clamping faces 56, each offset by 90° to the switch elements 76, which bear against the liquid store 102 and clamp this.

If the liquid store 102 is to be removed, the switch elements 76 are again pushed in and the clamping faces 56 separate from the casing surface 106 of the liquid store 102, so the liquid store 102 can be withdrawn from the receiving space 16 largely without force.

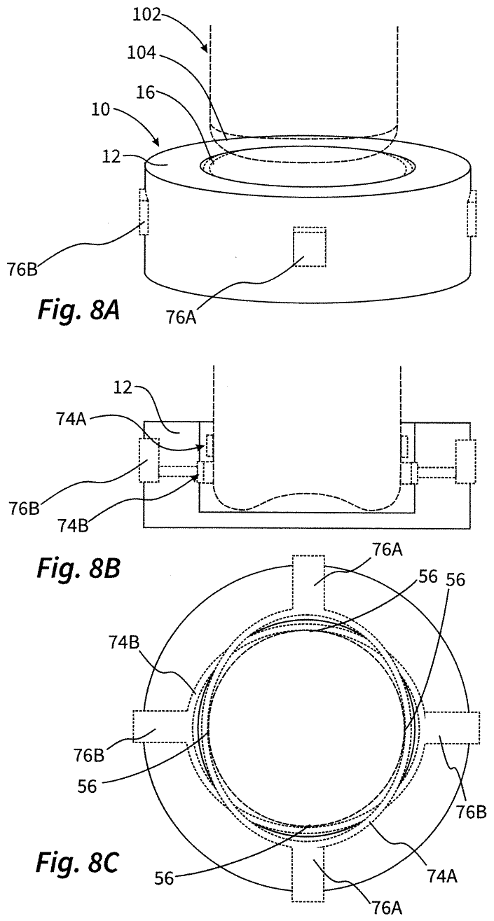

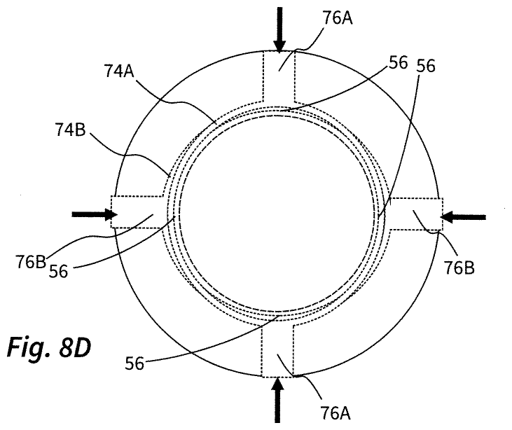

The design in FIGS. 8A to 8D is similar to the design in FIGS. 7A to 7D. However, here two clamping rings 74A, 74B are provided which are offset by 90° to one another and each have switch elements 76A, 76B. The function of each individual clamping ring 74A, 74B is identical to the above-mentioned exemplary embodiment. The special feature is that the two clamping rings 74A, 74B form a total of four clamping faces 56, which after release of the switch elements 76A, 76B bear against the outside of the liquid store 102.

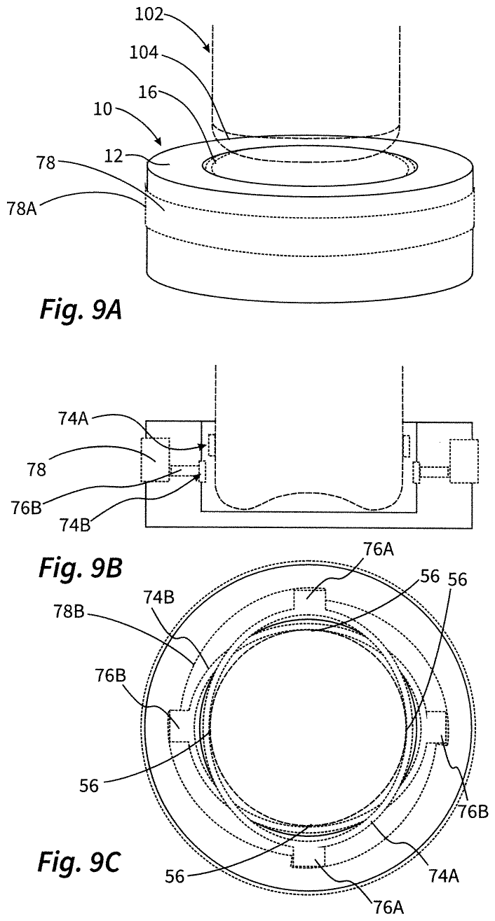

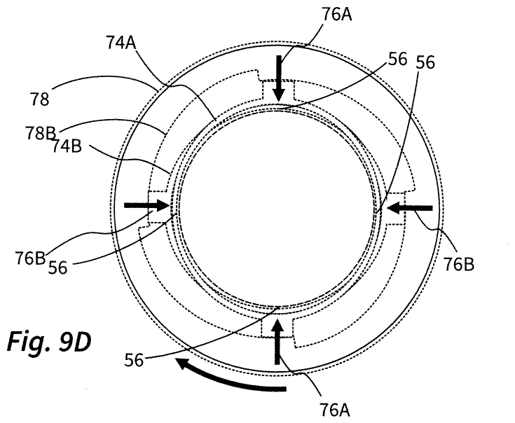

In the design in FIGS. 9A to 9D, again two clamping rings 74A, 74B are provided which are offset to one another by 90° corresponding to the design in FIGS. 8A to 8D. By deviation from the design in FIGS. 8A to 8D however, in the design in FIGS. 9A to 9D, a switch ring 78 is provided, the outside of which is formed by a grip face 78A and which on its inside has four force-loading faces 78B set slightly obliquely relative to the tangential direction. Instead of a direct manual force loading on the switch elements 76A, 76B of the clamping rings 74A, 74B, it is provided that only the switch ring 78 is directly manually displaced by the user, in a type of rotational movement. Indirectly, as FIG. 9D shows, all four switch elements 76A, 76B are pressed in by the force-loading faces 78B so that with a single action, both clamping rings 74A, 74B can be brought into the round form shown in FIG. 9D, in which the liquid store 102 can easily be inserted and removed again.

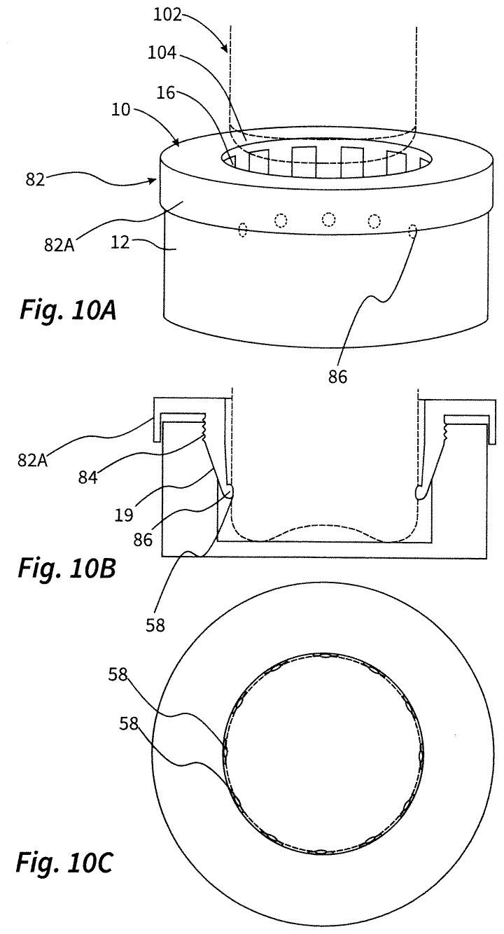

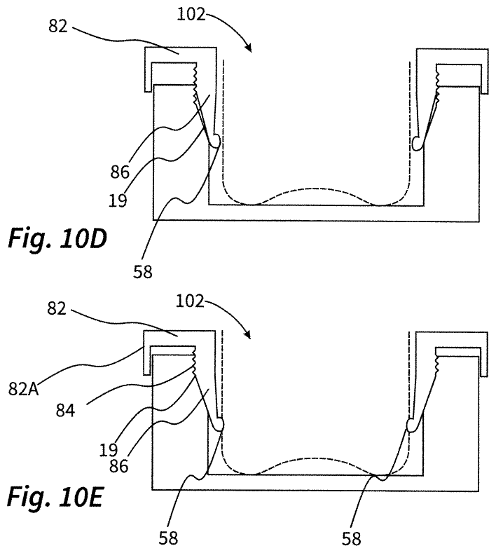

In the design in FIGS. 10A to 10C, a clamping sleeve 82 is placed on the wall structure 12 of the sensor unit 10, the outside of which is formed by a grip face 82A. The clamping sleeve 82 is attached to the housing 18 of the sensor unit 10 by means of a thread 84. A total of twelve clamping arms 86 are circumferentially distributed on the inside of the clamping sleeve 82, wherein the distal ends are formed by clamping faces 58 on the inside. The clamping arms 86 bear against a wedge surface 19 of the housing, which allows the clamping process illustrated in FIGS. 10D and 10E.

FIG. 10D shows the untensioned and hence unclamped state in which the liquid store 102 can easily be inserted and removed. In order to fasten the liquid store in the receiving space 16, after insertion of the liquid store 102, the clamping sleeve 80 can be screwed further onto the housing 18. This causes the clamping arms 86 to slide on the wedge surface 19 of the housing 18 so that, in the manner illustrated in FIG. 10E, they bear from the outside against the casing surface of the liquid store 102 and thereby securely fasten the liquid store 102.

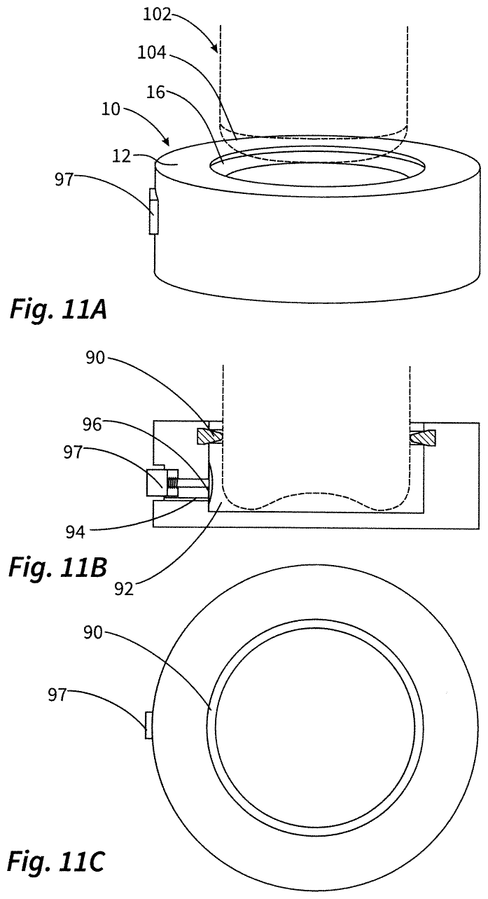

In the design in FIGS. 11A to 11C, it is provided that the receiving space 16 has a circumferential sealing element 90 on the inside of the wall structure 12. This sealing element 90 allows the majority of the receiving space 16 to form a pressure chamber 92 which is isolated from the environment when the liquid store 102 is inserted. If ambient pressure prevails in the pressure chamber 92, unintentional withdrawal of the liquid store 102 will form a vacuum, which counters the extraction of the liquid store 102.

In addition, in the design in FIGS. 11A to 11C, a pressure-balancing channel 94 is provided which can be closed by a valve 96 and also is normally closed by a spring force. By pressing a button 97, the pressure-balancing channel 94 can however be opened. In this open state, the liquid store 102 may be inserted without a positive pressure forming in the pressure chamber 92. When the liquid store 102 has been fully inserted, the valve 96 is closed and the liquid store is securely held. In addition to the vacuum in the pressure chamber 92 which forms on extraction of the liquid store, the sealing element 90 hinders withdrawal of the liquid store 102.

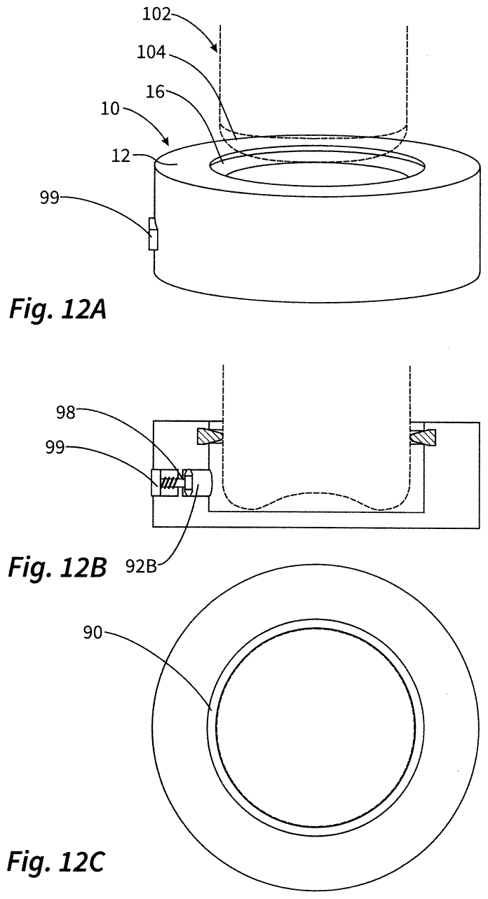

The design in FIGS. 12A to 12C again provides that a sealing element 90 creates a pressure chamber 92 which is isolated from the environment after insertion of the liquid store 102. The particular feature here is that, in addition to the pressure chamber 92 described with reference to the above example, an additional part chamber 92B is provided, the volume which can be changed by means of a piston switch element 98. When this switch element is pushed in by means of a button 99 on insertion of the liquid store, the volume of the part chamber 92B is low. When the button 99 is released after insertion of the liquid store, the part chamber 92B is enlarged and the pressure in the pressure chamber 92 reduced, further hindering withdrawal of the liquid store 102.

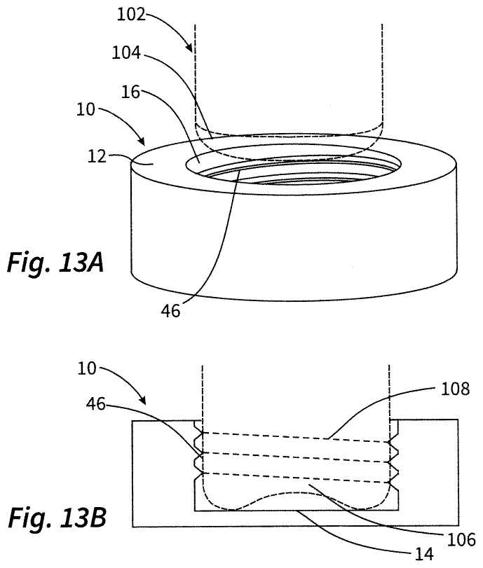

FIGS. 13A and 13B show a sensor unit according to the fourth variant of the invention. The sensor unit 10 has a thread structure 46 on the inside of the wall structure 12. This has an inner diameter which is smaller than the outer diameter of the casing surface 106 of the liquid store 102.

In the still uncoupled state, the liquid store 102 has no corresponding external thread. Nonetheless, it allows the sensor unit 10 to be screwed on, creating local helical compressions on the outside of the casing surface 106. With suitable choice of material and/or sufficient edge sharpness of the thread structure 46, the thread structure 46 can press into the casing surface 106 such that it creates an external thread 108.

1. A sensor unit for exchangeable attachment to a liquid dispenser having a liquid store with a casing surface, the casing surface having an outer diameter, and a bottom portion, the sensor comprising:
a receiving space, the receiving space being closed on a bottom side thereof by a receiving space floor, the receiving space floor for receiving the bottom portion of the liquid store;
an annular wall structure surrounding the receiving space and having an inside; and
at least one sensor for detecting handling of the liquid dispenser;
the sensor unit further comprising one of the following:
an adhesive element arranged between the receiving space floor and the bottom portion of the liquid store to secure the liquid store in the receiving space; or
at least one inwardly pointing and radially movable clamping face disposed on the inside of the annular wall structure for bearing in a securing fashion against the casing surface of the liquid store; or
a circumferential seal disposed on the inside of the annular wall for bearing against the casing surface of the liquid store and, the circumferential seal together with the casing surface and the bottom portion of the liquid store forming an isolated pressure chamber; or
a thread structure disposed on the inside of the annular wall for bearing in securing fashion against the casing surface of the liquid store, the thread structure having an inner diameter smaller than the outer diameter of the casing surface.

2. The sensor unit as claimed in claim 1, wherein
the adhesive element comprises an adhesive element with adhesive surfaces on opposite sides thereof, one of the adhesive surfaces being adhesively attached directly to a body integrally forming the liquid store and in contact with the liquid, and the other adhesive surface being adhesively attached to the receiving space floor.

3. The sensor unit as claimed in claim 1, wherein
the adhesive element comprises an adhesive element with adhesive surfaces on both sides.

4. The sensor unit as claimed in claim 2, wherein
the adhesive surface adhering to the receiving space floor has a greater separating force than the adhesive surface adhering to the bottom portion of the liquid dispenser.

5. The sensor unit as claimed in claim 1, wherein
the adhesive element comprises a polymer gel with adhesive properties.

6. The sensor unit as claimed in claim 1, wherein
the adhesive element comprises an annular form.

7. The sensor unit as claimed in claim 1, wherein:
the at least one clamping face comprises multiple discrete clamping faces distributed around a circumference of the inside of the annular wall; or
the at least one clamping face comprises a clamping face spanning the casing surface over at least 180° and/or a helical clamping face.

8. The sensor unit as claimed in claim 1, further including an at least partially radially elastically deflectable clamping element, and
the at least one clamping face is provided on the deflectable clamping element.

9. The sensor unit as claimed in claim 1, further including
at least one clamping element formed integrally with the annular wall structure.

10. The sensor unit as claimed in claim 9, wherein
the at least one clamping element has a radially compressible deformation region.

11. The sensor unit as claimed in claim 1, further including
a clamping element separate from the annular wall structure, the clamping element including the at least one clamping face and being deflectable or widenable relative to the annular wall structure.

12. The sensor unit as claimed in claim 11, wherein
the clamping element comprises a widenable ring or a widenable leg spring, wherein one end of the ring or leg spring is attached to the annular wall structure and another end of the ring or leg spring is movable for widening the ring or leg spring.

13. The sensor unit as claimed in claim 1, further comprising a circumferential clamping ring and the at least one clamping face comprises
at least two clamping faces arranged opposite one another on an inside of the circumferential clamping ring, and
the clamping ring comprises an oval form deformable elastically into a circular form under radial force loading.

14. The sensor unit as claimed in claim 13, wherein the at least one clamping face comprises a plurality of clamping faces, the sensor unit further including
at least two clamping rings, each of the clamping rings having two of the plurality of clamping faces arranged opposite one another on an inside of the respective clamping ring, wherein both clamping rings have an oval form deformable elastically into a circular form under radial force loading.

15. The sensor unit as claimed in claim 13, further comprising push-in switch elements
for direct or indirect manual force loading of the clamping ring, the switch elements protruding through the annular wall structure.

16. The sensor unit as claimed in claim 13, further comprising at least one switch element
for force loading the clamping ring, the at least one switch element being movable relative to the wall structure and formed as a component separate from the clamping ring, and
the switch element has a force-loading face inside thereof for force loading clamping ring.

17. The sensor unit as claimed in claim 1, further including a clamping element, wherein
the at least one clamping face forms an inside face of the clamping element, the clamping element comprising an elastically compressible material.

18. The sensor unit as claimed in claim 17, wherein
the elastically compressible material comprises a porous elastic material.

19. The sensor unit as claimed in claim 1, further comprising
an axially movable clamping sleeve, and
the at least one clamping face comprises a plurality of clamping faces radially displaced by axial displacement of the clamping sleeve.

20. The sensor unit as claimed in claim 1, wherein
the pressure chamber comprises a part chamber with a variable volume, and the sensor unit further comprises
a switch element for manually changing the volume of the part chamber.

21. The sensor unit as claimed in claim 1, further comprising
a pressure-balancing channel connecting the pressure chamber to an environment,
a manually switchable valve, the manually switchable valve closing the pressure-balancing channel to isolate the pressure chamber from the environment.

22. The sensor unit as claimed in claim 1, wherein
the sensor unit has at least one sensor comprising a movement sensor, a position sensor, an acceleration sensor, an acoustic sensor, a temperature sensor, an optical sensor, a force sensor or a pressure sensor; and/or
the sensor unit comprises a radio communication module; and/or
the sensor unit comprises a processor and a memory connected to the processor or integrated in the processor, the memory containing the program code for execution by the processor.

23. A liquid dispenser, the liquid dispenser comprising:
a liquid store having a bottom portion;
a delivery head attached to the liquid store and having a delivery opening for discharge of liquid;
a sensor unit attached to the bottom portion of the liquid store opposite the delivery head, the sensor unit comprising:
a receiving space, the receiving space being closed on a bottom side thereof by a receiving space floor, the receiving space floor for receiving the bottom portion of the liquid store;
an annular wall structure surrounding the receiving space and having an inside; and
at least one sensor for detecting handling of the liquid dispenser;
the sensor unit further comprising one of the following:
an adhesive element arranged between the receiving space floor and the bottom portion of the liquid store to secure the liquid store in the receiving space; or
at least one inwardly pointing and radially movable clamping face disposed on the inside of the annular wall structure for bearing in a securing fashion against the casing surface of the liquid store; or
a circumferential seal disposed on the inside of the annular wall for bearing against the casing surface of the liquid store and, the circumferential seal together with the casing surface and the bottom portion of the liquid store forming an isolated pressure chamber; or
a thread structure disposed on the inside of the annular wall for bearing in a securing fashion against the casing surface of the liquid store, the thread structure having an inner diameter smaller than the outer diameter of the casing surface.

24. The liquid dispenser as claimed in claim 23, wherein
the liquid store a squeeze bottle.

25. The liquid dispenser as claimed in claim 23, wherein
the liquid dispenser comprises a spray dispenser or drop dispenser.

26. The liquid dispenser as claimed in claim 23, wherein
the liquid store is filled with a pharmaceutical liquid.

27. The sensor unit as claimed in claim 19, wherein the clamping faces are formed integrally with the clamping sleeve and on an inside of the clamping sleeve, and/or the clamping sleeve is axially displaceable via a thread, and/or the clamping sleeve has a grip face forming an outside of the sensor unit.
